(19) United States
(12) Patent Application Publication
(10) Pub. No.: US 2018/0048943 A1
(43) Pub. Date: Feb. 15, 2018

(54) METHOD AND SYSTEM FOR RENDERING TIME-COMPRESSED MULTIMEDIA CONTENT

(71) Applicant: YEN4KEN, INC., Princeton, NJ (US)

(72) Inventors: Vinay Melkote, Bangalore (IN); Om D. Deshmukh, Bangalore (IN); Sumit Negi, Bangalore (IN); Sonal S. Patil, Dhule (IN); Ankita Patil, Gulbarga (IN)

(21) Appl. No.: 15/234,085

(22) Filed: Aug. 11, 2016

(51) Int. Cl. H04N 21/6587; H04N 21/435; G09B 5/06; H04N 21/442; H04N 21/439; H04N 21/2662; G11B 27/00; H04N 21/4402

(52) U.S. Cl. CPC H04N 21/6587; G11B 27/005; H04N 21/435; H04N 21/440281; H04N 21/44209; H04N 21/4394; H04N 21/2662; G09B 5/06

(57) ABSTRACT

The disclosed embodiments illustrate method for rendering time-compressed multimedia content on a user-computing device. The method includes determining metadata for one or more frames in multimedia content based on each of one or more time-compression factors and one or more attributes of the multimedia content. Further, the determined metadata comprises a binary value associated with each of the one or more frames of the multimedia content. The method further includes transmitting the multimedia content associated with the determined metadata to the user-computing device, based at least on a time-compression factor in a user request received from the user-computing device. Further, the transmitted multimedia content is rendered on the user-computing device as the time-compressed multimedia content.

### TECHNICAL FIELD

The presently disclosed embodiments are related, in general, to multimedia content processing. More particularly, the presently disclosed embodiments are related to methods and systems for rendering time-compressed multimedia content on a user-computing device.

### BACKGROUND

Advancements in the field of online education have made Massive Open Online Courses (MOCCs) a popular mode of learning. Educational organizations provide various types of multimedia content, such as video and/or audio lectures, to students for learning. Such multimedia content may contain one or more topics discussed over playback duration of the multimedia content.

Usually, the playback duration of such multimedia content (e.g., educational multimedia content) is lengthy and has large digital footprints compared with the duration of non-educational multimedia content. In certain scenarios, it may be difficult for a user to download the entire multimedia content due to various reasons, such as limited bandwidth. In such scenarios, the user may want to time-compress the multimedia content in order to shorten the length of the multimedia content. However, the user may still want the core information of the multimedia content to be preserved in the time-compressed version of the multimedia content. Apparently, the manual identification of portions of the multimedia content that contain the core information is an arduous task. Thus, there is a requirement for an efficient and automated mechanism that preserves the core information in the time-compressed multimedia content.

Further limitations and disadvantages of conventional and traditional approaches will become apparent to a person having ordinary skill in the art, through a comparison of described systems with some aspects of the present disclosure, as set forth in the remainder of the present application and with reference to the drawings.

### SUMMARY

According to embodiments illustrated herein, there may be provided a method of data processing for rendering time-compressed multimedia content on a user-computing device. The method includes determining, by one or more processors in a computing device, metadata for one or more frames in multimedia content based on each of one or more time-compression factors and one or more attributes of the multimedia content, wherein the determined metadata comprises a binary value associated with each of the one or more frames of the multimedia content. The method further includes transmitting, by the one or more processors in the computing device, the multimedia content associated with the determined metadata to the user-computing device, based at least on a time-compression factor in a user request received from the user-computing device, wherein the transmitted multimedia content is rendered on the user-computing device as the time-compressed multimedia content.

According to embodiments illustrated herein, there may be provided a system of data processing for rendering time-compressed multimedia content on a user-computing device. The system includes one or more processors configured to determine metadata for one or more frames in multimedia content based on each of one or more time-compression factors and one or more attributes of the multimedia content, wherein the determined metadata comprises a binary value associated with each of the one or more frames of the multimedia content. The system includes the one or more processors further configured to transmit the multimedia content associated with the determined metadata to the user-computing device, based at least on a time-compression factor in a user request received from the user-computing device, wherein the transmitted multimedia content is rendered on the user-computing device as the time-compressed multimedia content.

According to embodiments illustrated herein, there may be provided a computer program product for use with a computing device. The computer program product comprises a non-transitory computer readable medium storing a computer program code of data processing for rendering time-compressed multimedia content on a user-computing device. The computer program code is executable by one or more processors to determine metadata for one or more frames in multimedia content based on each of one or more time-compression factors and one or more attributes of the multimedia content, wherein the determined metadata comprises a binary value associated with each of the one or more frames of the multimedia content. The computer program code is further executable by the one or more processors to transmit the multimedia content associated with the determined metadata to the user-computing device, based at least on a time-compression factor in a user request received from the user-computing device, wherein the transmitted multimedia content is rendered on the user-computing device as the time-compressed multimedia content.

### BRIEF DESCRIPTION OF DRAWINGS

The accompanying drawings illustrate the various embodiments of systems, methods, and other aspects of the disclosure. Any person with ordinary skills in the art will appreciate that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice versa. Further, the elements may not be drawn to scale.

Various embodiments will hereinafter be described in accordance with the appended drawings, which are provided to illustrate and not to limit the scope in any manner, wherein similar designations denote similar elements, and in which:

FIG. 1 is a block diagram that illustrates a system environment in which various embodiments can be implemented, in accordance with at least one embodiment;

FIG. 2 is a block diagram that illustrates an application server, in accordance with at least one embodiment; and

FIG. 3 is a flowchart that illustrates a method to render time-compressed multimedia content on a user-computing device, in accordance with at least one embodiment.

FIG. 4A is an illustrative example for rendering time-compressed multimedia content on a user-computing device when network bandwidth is greater than a pre-defined bandwidth threshold, in accordance with at least one embodiment.

FIG. 4B is an illustrative example for rendering time-compressed multimedia content on a user-computing device when network bandwidth is below a pre-defined bandwidth threshold, in accordance with at least one embodiment.

### DETAILED DESCRIPTION

The present disclosure may be best understood with reference to the detailed figures and description set forth herein. Various embodiments are discussed below with reference to the figures. However, those skilled in the art will readily appreciate that the detailed descriptions given herein with respect to the figures are simply for explanatory purposes, as the methods and systems may extend beyond the described embodiments. For example, the teachings presented and the needs of a particular application may yield multiple alternative and suitable approaches to implement the functionality of any detail described herein. Therefore, any approach may extend beyond the particular implementation choices in the following embodiments described and shown.

References to “one embodiment,” “at least one embodiment,” “an embodiment,” “one example,” “an example,” “for example,” and so on indicate that the embodiment(s) or example(s) may include a particular feature, structure, characteristic, property, element, or limitation but that not every embodiment or example necessarily includes that particular feature, structure, characteristic, property, element, or limitation. Further, repeated use of the phrase “in an embodiment” does not necessarily refer to the same embodiment.

Definitions: The following terms shall have, for the purposes of this application, the respective meanings set forth below.

“Multimedia content” refers to content that uses a combination of different content forms, such as text content, audio content, image content, animation content, video content, and/or interactive content. In an embodiment, the multimedia content may comprise one or more frames. In an embodiment, the multimedia content may be reproduced on a user-computing device through an application, such as a media player (e.g. Windows Media Player®, Adobe® Flash Player, Apple® QuickTime®, and/or the like). In an embodiment, the multimedia content may be downloaded from a server to the user-computing device. In an alternate embodiment, the multimedia content may be retrieved from a media storage device, such as hard disk drive (HDD), CD drive, pen drive, and/or the like, connected to (or within) the user-computing device.

A “frame” refers to a set of pixel data with information about an image that corresponds to a single picture or a still shot that is a part of multimedia content. In an embodiment, the multimedia content may comprise one or more frames that are rendered in succession, on a display device, to present a seamless piece of the multimedia content.

A “user-computing device” refers to a computer, a device (that includes a processor/microcontroller and/or any other electronic component, or device), or system (that performs one or more operations according to one or more programming instructions) associated with a user. Examples of the user-computing device include, but are not limited to, a desktop computer, a laptop, a personal digital assistant (PDA), a mobile device, a smartphone, a tablet computer (e.g., iPad® and Samsung Galaxy Tab®) or the like. The user-computing device is capable of accessing (or being accessed over) a network (e.g., using wired or wireless communication capability). In an embodiment, the user-computing device may be utilized for rendering time-compressed multimedia content. Further, the user-computing device may display an output, to the user, based on the received input.

“Metadata” refers to additional information that is associated with one or more frames in multimedia content. In an embodiment, the additional information may include, but is not limited to, a binary value associated with each of the one or more frames of the multimedia content, and/or the like.

“One or more attributes” refer to one or more parameters associated with multimedia content. In an embodiment, the one or more attributes may comprise a count of frames to be included in time-compressed multimedia content, a speech rate, an identity of a speaker in audio content of the multimedia content, presence of one or more pre-defined filler words, and historical data of a user. In an embodiment, the one or more attributes of the multimedia content may be determined to identify frames associated with core information of the multimedia content. Further, the one or more attributes of the multimedia content may be utilized to determine metadata for the multimedia content.

“One or more sequential levels” refer to a multi-layered sequence of multimedia content. Each sequential level in the one or more sequential levels comprises encoded information pertaining to a set of frames, from one or more frames of the multimedia content, associated with a specific time-compression factor of one or more time-compression factors. In an embodiment, the one or more sequential levels are determined when a network bandwidth is below a pre-defined bandwidth threshold.

“One or more time-compression factors” refer to compression factors based on which playback time of multimedia content is reduced. For example, for a time compression factor “2,” the playback time of multimedia content is reduced to half.

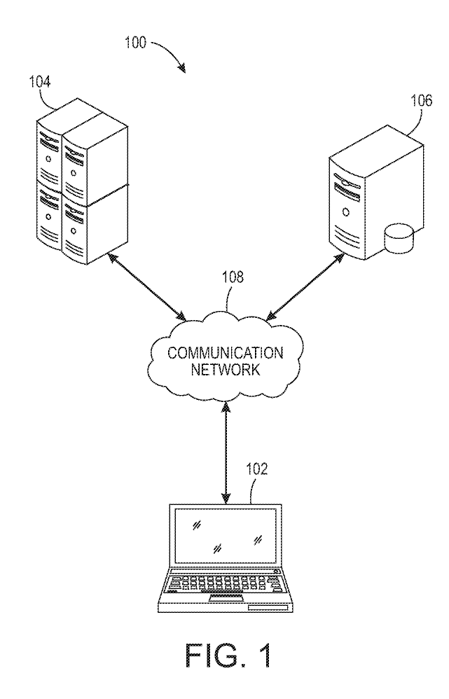

FIG. 1 is a block diagram of a system environment in which various embodiments can be implemented. With reference to FIG. 1, there is shown a system environment 100 that includes a user-computing device 102, an application server 104, a database server 106, and a communication network 108. Various devices in the system environment 100 may be interconnected over the communication network 108. FIG. 1 shows, for simplicity, one user-computing device, such as the user-computing device 102, one application server, such as the application server 104, and one database server, such as the database server 106. However, it will be apparent to a person having ordinary skill in the art that the disclosed embodiments may also be implemented using multiple user-computing devices, multiple application servers, and multiple database servers, without departing from the scope of the disclosure.

The user-computing device 102 may refer to a computing device (associated with a user) that may be communicatively coupled to the communication network 108. The user-computing device 102 may include one or more processors and one or more memory units. The one or more memory units may include a computer readable code that may be executable by the one or more processors to perform one or more operations. In an embodiment, the user may utilize the user-computing device 102 to transmit a user request, to the application server 104, for rendering a time-compressed version of multimedia content on the user-computing device 102. The user request may include a time-compression factor of one or more time-compression factors. The user-request may further include a selection parameter for selecting the multimedia content. In an embodiment, the user-computing device 102 may include hardware and/or software that may be configured to display the multimedia content on the user-computing device 102. In an embodiment, the user-computing device 102 may be further configured to display a user-interface, received from the application server 104, to the user. In an embodiment, the time-compressed multimedia content may be rendered on the user-computing device 102 through the received user-interface. In an embodiment, an application for a metadata driven player may be installed in the user-computing device 102 that may be configured to read the metadata associated with the multimedia content. Further, one or more media player applications may be installed in the user-computing device 102. The metadata driven player may work in conjunction with the one or more media player applications to render the time-compressed multimedia content on a display screen of the user-computing device 102 based on the read metadata. Examples of the user-computing device 102 may include, but are not limited to, a personal computer, a laptop, a personal digital assistant (PDA), a mobile device, a tablet, or any other computing device.

A person having ordinary skill in the art will understand that the scope of the disclosure is not limited to the utilization of the user-computing device 102 by a single user. In an embodiment, more than one user may utilize the user-computing device 102 to transmit the user request.

The application server 104 refers to a computing device or a software framework hosting an application or a software service that may be communicatively coupled to the communication network 108. In an embodiment, the application server 104 may be implemented to execute procedures, such as, but not limited to, programs, routines, or scripts stored in one or more memory units for supporting the hosted application or the software service. In an embodiment, the hosted application or the software service may be configured to perform one or more predetermined operations. In an embodiment, the one or more predetermined operations may include rendering the time-compressed multimedia content on the user-computing device 102 associated with the user.

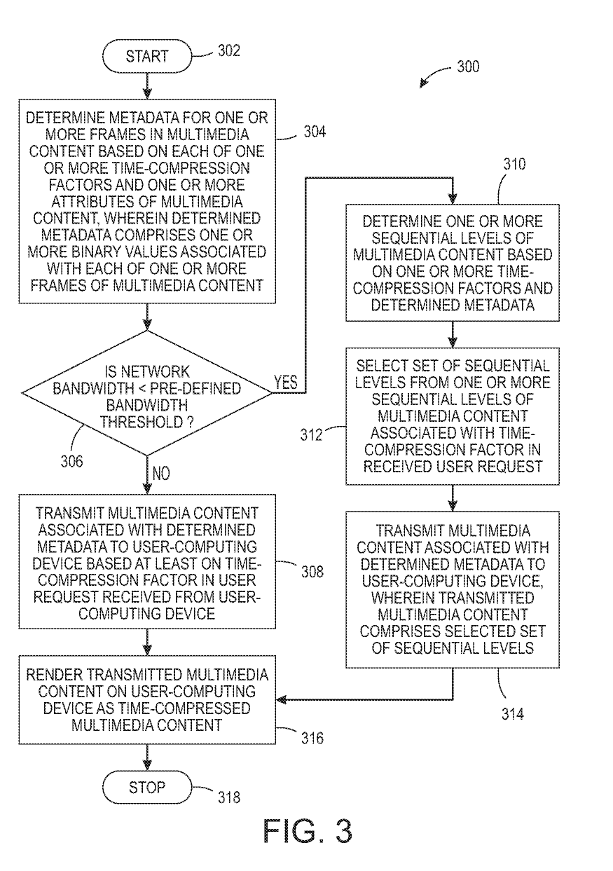

In an embodiment, the application server 104 may be configured to select the multimedia content, based on the selection parameter provided by the user in the user request. In an embodiment, the application server 104 may query the database server 106 for the retrieval of the selected multimedia content. In an alternate embodiment, the application server 104 may receive the multimedia content from the user-computing device 102. In an embodiment, the application server 104 may be configured to determine one or more attributes from the multimedia content. In an embodiment, the one or more attributes may comprise one or more of a count of frames to be included in the time-compressed multimedia content, a speech rate, an identity of a speaker in audio content of the multimedia content, presence of one or more pre-defined filler words, and historical data of the user. In an embodiment, the historical data may correspond to information pertaining to a prior interaction of the user with another multimedia content. The determination of the one or more attributes from the multimedia content has been described later in FIG. 3.

In an embodiment, the application server 104 may be further configured to determine metadata for one or more frames in the multimedia content. The application server 104 may be configured to determine the metadata based on the determined one or more attributes. In an embodiment, the application server 104 may be further configured to determine the metadata based on each of the one or more time-compression factors. The metadata may comprise binary values associated with the one or more frames in the multimedia content.

In an embodiment, the application server 104 may be further configured to transmit the multimedia content associated with the determined metadata to the user-computing device 102, based on at least the time-compression factor in the user request. In an embodiment, the application server 104 may render the time-compressed multimedia content on the user-computing device 102 through the user-interface.

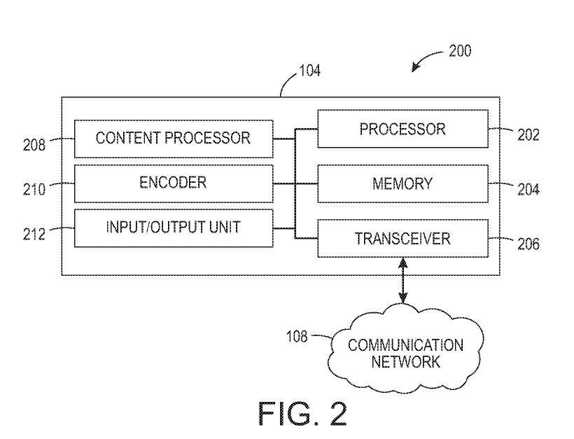

The application server 104 may be realized through various types of application servers such as, but not limited to, a Java application server, a .NET framework application server, a Base4 application server, a PHP framework application server, or any other application server framework. An embodiment of the structure of the application server 104 is described later in FIG. 2.

A person having ordinary skill in the art will appreciate that the scope of the disclosure is not limited to realizing the application server 104 and the user-computing device 102 as separate entities. In an embodiment, the application server 104 may be realized as an application program installed on and/or running on the user-computing device 102, without departing from the scope of the disclosure.

The database server 106 may refer to a computing device or a storage device that may be communicatively coupled to the communication network 108 to perform one or more database operations. In an embodiment, the one or more database operations may include one or more of, but not limited to, receiving, storing, processing, and transmitting one or more queries, data, or content. In an embodiment, the database server 106 may be configured to store multimedia content and the historical data. In an embodiment, the database server 106 may be configured to receive the multimedia content from one or more websites. In an embodiment, the historical data of the user may comprise the information pertaining to the prior interaction of the user with other multimedia content.

In an embodiment, the database server 106 may be configured to receive the query for the retrieval of the multimedia content and the historical data from the application server 104. Thereafter, the database server 106 may be configured to transmit the multimedia content and the historical data of the user to the application server 104 based on the received query. For querying the database server 106, one or more querying languages may be utilized, such as, but not limited to, SQL, QUEL, and DMX. In an embodiment, the database server 106 may be realized through various technologies, such as, but not limited to, Microsoft® SQL Server, Oracle®, IBM DB2®, Microsoft Access®, PostgreSQL®, MySQL® and SQLite®.

A person having ordinary skill in the art will appreciate that the scope of the disclosure is not limited to realizing the database server 106 and the application server 104 as separate entities. In an embodiment, the functionalities of the database server 106 may be integrated into the application server 104, without departing from the scope of the disclosure.

In an embodiment, the communication network 108 may correspond to a communication medium through which the user-computing device 102, the application server 104, and the database server 106 may communicate with each other. Such a communication may be performed, in accordance with various wired and wireless communication protocols. Examples of such wired and wireless communication protocols may include, but are not limited to, Transmission Control Protocol and Internet Protocol (TCP/IP), User Datagram Protocol (UDP), Hypertext Transfer Protocol (HTTP), File Transfer Protocol (FTP), ZigBee, EDGE, infrared (IR), IEEE 802.11, 802.16, 2G, 3G, 4G cellular communication protocols, and/or Bluetooth (BT) communication protocols. The communication network 108 may include, but is not limited to, the Internet, a cloud network, a Wireless Fidelity (Wi-Fi) network, a Wireless Local Area Network (WLAN), a Local Area Network (LAN), Long-Term Evolution (LTE), a telephone line (POTS), and/or a Metropolitan Area Network (MAN).

FIG. 2 is a block diagram that illustrates an application server, in accordance with at least one embodiment. FIG. 2 has been described in conjunction with FIG. 1. With reference to FIG. 2, there is shown the application server 104 that may include a processor 202, a memory 204, a transceiver 206, a content processor 208, an encoder 210, and an input/output unit 212. The processor 202 is communicatively coupled to the memory 204, the transceiver 206, the content processor 208, the encoder 210, and the input/output unit 212.

The processor 202 includes suitable logic, circuitry, interfaces, and/or code that are operable to execute one or more instructions stored in the memory 204. The processor 202 may further comprise an arithmetic logic unit (ALU) (not shown) and a control unit (not shown). The ALU may be coupled to the control unit. The ALU may be configured to perform one or more mathematical and logical operations and the control unit may control the operation of the ALU. The processor 202 may execute a set of instructions/programs/codes/scripts stored in the memory 204 to perform the one or more predetermined operations.

In an embodiment, the one or more predetermined operations may include determining metadata for the one or more frames in the multimedia content based on each of the one or more time-compression factors and the one or more attributes of the multimedia content. In an embodiment, the processor 202 may be configured to determine one or more sequential levels of the multimedia content, when a network bandwidth is below a pre-defined bandwidth threshold. Each sequential level may be associated with a time compression factor of the one or more time-compression factors. Further, each sequential level of the one or more sequential levels comprises a set of frames from the one or more frames of the multimedia content. In an embodiment, the processor 202 may be configured to determine the set of frames to be included in a sequential level based on the binary values in the determined metadata associated with the time-compression factor of the sequential level. The processor 202 may be implemented using one or more processor technologies known in the art. Examples of the processor 202 may include, but are not limited to, an x86 processor, an ARM processor, a Reduced Instruction Set Computing (RISC) processor, an Application Specific Integrated Circuit (ASIC) processor, a Complex Instruction Set Computing (CISC) processor, and/or any other processor.

The memory 204 may be operable to store one or more machine codes, and/or computer programs having at least one code section executable by the processor 202. The memory 204 may store the one or more sets of instructions that are executable by the processor 202, the transceiver 206, the content processor 208, the encoder 210, and the input/output unit 212. In an embodiment, the memory 204 may include the one or more machine codes, and/or computer programs that are executable by the processor 202 to perform the one or more predetermined operations. In an embodiment, the memory 204 may include one or more buffers (not shown). In an embodiment, the one or more buffers may be configured to store the determined metadata associated with the multimedia content. Some of the commonly known memory implementations may include, but are not limited to, a random access memory (RAM), a read only memory (ROM), a hard disk drive (HDD), and a secure digital (SD) card.

The transceiver 206 comprises suitable logic, circuitry, and/or interfaces that may be configured to receive or transmit the one or more queries, data, content, or other information to/from various components, such as the user-computing device 102 and the database server 106 of the system environment 100, over the communication network 108. In an embodiment, the transceiver 206 may be communicatively coupled to the communication network 108. In an embodiment, the transceiver 206 may be configured to receive the multimedia content from the database server 106. Further, the transceiver 206 may be configured to transmit the user interface to the user-computing device 102, through which the multimedia content is rendered on the user-computing device 102. In an embodiment, the transceiver 206 may include, but is not limited to, an antenna, a radio frequency (RF) transceiver, one or more amplifiers, a tuner, one or more oscillators, a digital signal processor, a Universal Serial Bus (USB) device, a coder-decoder (CODEC) chipset, a subscriber identity module (SIM) card, and/or a local buffer. The transceiver 206 may communicate via wireless communication with networks, such as the Internet, an Intranet and/or a wireless network, such as a cellular telephone network, a wireless local area network (LAN) and/or a metropolitan area network (MAN). The wireless communication may use any of a plurality of communication standards, protocols and technologies, such as Global System for Mobile Communications (GSM), Enhanced Data GSM Evolution (EDGE), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for email, instant messaging, and/or Short Message Service (SMS).

The content processor 208 includes suitable logic, circuitry, interfaces, and/or code that may be configured to execute the one or more sets of instructions stored in the memory 204. In an embodiment, the content processor 208 may be configured to determine the one or more attributes from the multimedia content. In an embodiment, the content processor 208 may utilize one or more attribute detection algorithms, known in the art, for the identification of the one or more attributes associated with the multimedia content. In an embodiment, the content processor 208 may be further configured to determine the metadata for the multimedia content, based on the one or more attributes. In an embodiment, the content processor 208 may be further configured to determine the count of frames to be included in the time-compressed multimedia content, the speech rate, an identity of a speaker in the audio content of the multimedia content, presence of the one or more pre-defined filler words, and the historical data of the user. The content processor 208 may be implemented based on a number of processor technologies known in the art. Examples of the content processor 208 may include, but are not limited to, a word processor, an X86-based processor, a RISC processor, an ASIC processor, and/or a CISC processor.

The encoder 210 includes suitable logic, circuitry, interfaces, and/or code that may be configured to execute the one or more sets of instructions stored in the memory 204. In an embodiment, the encoder 210 may be configured to determine the one or more sequential levels of the multimedia content based on the one or more time-compression factors and the determined metadata. In an embodiment, the encoder 210 may be configured to encode information pertaining to a set of frames (associated with a time compression factor) in one or more frames of the multimedia content for determining the corresponding sequential level (associated with the time compression factor). Further, the encoder 210 may be configured to embed the metadata with the multimedia content, when the time-compressed multimedia content is transmitted to the user-computing device 102 over a network with network bandwidth greater than the pre-defined bandwidth threshold.

A person having ordinary skill in the art will understand that the scope of the disclosure is not limited to realizing the encoder 210 as a hardware component. In an embodiment, the encoder 210 may be implemented as a software module included in computer program code (stored in the memory 204), which may be executable by the processor 202 to perform the functionalities of the encoder 210.

The input/output unit 212 comprises suitable logic, circuitry, interfaces, and/or code that may be configured to receive an input or transmit an output to the user-computing device 102. The input/output unit 212 comprises various input and output devices that are configured to communicate with the processor 202. Examples of the input devices include, but are not limited to, a keyboard, a mouse, a joystick, a touch screen, a microphone, a camera, and/or a docking station. Examples of the output devices include, but are not limited to, a display screen and/or a speaker.

FIG. 3 is a flowchart that illustrates a method to render time-compressed multimedia content on a user-computing device, in accordance with at least one embodiment. FIG. 3 is described in conjunction with FIG. 1 and FIG. 2. With reference to FIG. 3, there is shown a flowchart 300 that illustrates the method to render time-compressed multimedia content on the user-computing device 102. The method starts at step 302 and proceeds to step 304.

At step 304, the metadata is determined based on each of the one or more time-compression factors and the one or more attributes of multimedia content. The determined metadata comprises binary values associated with each of the one or more frames of the multimedia content. In an embodiment, the content processor 208, in conjunction with the processor 202, may be configured to determine the metadata for the one or more frames in the multimedia content based on each of the one or more time-compression factors and the one or more attributes of the multimedia content. The determined metadata may comprise binary values associated with each of the one or more frames of the multimedia content. In an embodiment, the one or more attributes of multimedia content may comprise one or more of the count of frames to be included in the time-compressed multimedia content, the speech rate, and the identity of the speaker in the audio content of the multimedia content. The one or more attributes of multimedia content may further comprise the presence of the one or more pre-defined filler words and the historical data of the user.

Prior to the determination of the metadata, the user request to render time compressed multimedia content may be received from the user-computing device 102. In an embodiment, the transceiver 206 may be configured to receive the request, for rendering the time compressed multimedia content, from the user-computing device 102, over the communication network 108. The user request may further comprise information pertaining to a time-compression factor and the selection parameter of the multimedia content. Thereafter, the processor 202, in conjunction with the transceiver 206, may be configured to query the database server 106 for retrieving the multimedia content based on the selection parameter in the user request.

After the retrieval, the content processor 208, in conjunction with the processor 202, may be configured to process the multimedia content for determining the one or more attributes of the multimedia content. The one or more attributes may comprise one or more of: the count of frames to be included in the time-compressed multimedia content, the speech rate, the identity of a speaker in audio content of the multimedia content, the presence of the one or more pre-defined filler words, and the historical data of the user. A person having ordinary skill in the art will understand that for brevity, the determination of the metadata, based on the one or more attributes is described for one time-compression factor T₁. However, the metadata may also be determined for the remaining time-compression factors.

### Count of Frames N:

In an embodiment, the processor 202 may be configured to determine the count of frames N to be included in the time-compressed multimedia content. In an embodiment, the processor 202 may utilize the time-compression factor T₁ to determine the count of frames N to be included in the time-compressed multimedia content associated with the time-compression factor T₁. In an embodiment, the processor 202 may determine a ratio between a count of the one or more frames in multimedia content and the time-compression factor T₁, to determine the count of frames N to be included in the time-compressed multimedia content associated with the time-compression factor T₁. In an exemplary scenario, multimedia content “A” comprises “2000” frames. For a time-compression factor (i.e., T₁=2), the processor 202 may determine the ratio as “2000/2.” Based on the ratio, the processor 202 determines the count of frames (i. e., N=1000) to be included in the time-compressed multimedia content associated with the time-compression factor (i.e., T₁=2). For another time-compression factor (i.e., T₁=10), the processor 202 may determine the ratio “2000/10.” Based on the ratio, the processor 202 determines the count of frames (i.e., N=200) to be included in the time-compressed multimedia content associated with the time-compression factor (i. e., T₁=10).

A person having ordinary skill in the art will understand that the abovementioned exemplary scenario is for illustrative purpose and should not be construed to limit the scope of the disclosure.

After determining the count of frames for the time-compression factor T₁, in an embodiment, the processor 202 may be configured to identify a set of frames, from the one or more frames, of count N to be included in the time-compressed multimedia content. The processor 202 may be configured to utilize one or more dynamic time warping techniques to identify the set of frames.

In an exemplary scenario, multimedia content S comprises K frames, with adjacent frames having an overlap of “50%.” The processor 202 receives a user-request from the user-computing device 102 to time-compress the multimedia content S with the time-compression factor T₁. The processor 202 determines the count of frames N=K/T₁. Further, the processor 202 utilizes a dynamic time warping technique to build a graph G. The graph G comprises a plurality of nodes. Further, each node in the graph G indicates a mapping between one frame of the multimedia content S (represented by X-axis) and another frame in itself (represented by Y-axis). The processor 202 may further determine a path P through the graph G that comprises K/T₁ jumps. For the determination of the path P, the processor 202 may determine a distortion metric for each node in the graph G. The distortion metric of a node corresponds to one of a mean squared error between Mel-Frequency Cepstral Coefficients (MFCC) coefficients or Itakura-Saito distance (known in the art) between the frames associated with the node. For example, distortion metric of a node “n” (i.e., mapping of a frame “a” with another frame “b”) corresponds to mean squared error between MFCC coefficients of the frame “a” and the frame “b.” Thereafter, the processor 202 selects a set of nodes of count N (i.e., the path P) in the graph G with a minimum sum of distortion metrics by utilizing equation (1), as shown below:

$$P = {argmin}_{N} {\sum }_{K = 0}^{K - 1} D ( {s}_{0} , {s}_{{m}_{0}} ) \qquad ( 1 )$$

where,

D(s₀,sₘ_{₀}) represents distortion metric of a node comprising frames s₀ and sₘ_{₀}. In an embodiment, each selected node in the set of nodes may correspond to a jump in the path P. Thereafter, the processor 202 may identify the Y-axis counterparts in the selected set of nodes as the set of frames of count N to be included in the time-compressed multimedia content.

A person having ordinary skill in the art will understand that the abovementioned exemplary scenario is for illustrative purpose and should not be construed to limit the scope of the disclosure.

After identifying the set of frames, in an embodiment, the processor 202 may be configured to determine the metadata for the one or more frames in the multimedia content. For example, the processor 202 may assign a binary value “1” to the identified set of frames and a binary value “0” to the remaining one or more frames. In an embodiment, the assigned binary values to the one or more frames may correspond to the metadata of the multimedia content pertaining to the time-compression factor T₁.

A person having ordinary skill in the art will understand that the abovementioned examples are for illustrative purpose and should not be construed to limit the scope of the disclosure.

### Speech Rate R:

In an embodiment, the content processor 208 may be configured to determine the speech rate R associated with the audio content in the multimedia content. In an exemplary scenario, the multimedia content may correspond to educational content comprising an instructor who teaches a topic to a plurality of students. The educational content comprises the voice of the instructor, the voice of the plurality of students and other sounds. Further, the voice of the instructor, the voice of the plurality of students and other sounds collectively correspond to the audio content of the educational content. The content processor 208 may utilize one or more speech processing techniques, such as voice activity detection (VAD) techniques, to determine the speech rate R associated with the audio content of the educational content.

In an embodiment, the content processor 208 may be configured to determine a speech rate contour for the determined speech rate R associated with the audio content. The speech rate contour may comprise a temporal mapping of the determined speech rate R with the one or more frames of the multimedia content. In an embodiment, the content processor 208 may be further configured to utilize the speech rate contour to determine the set of frames of count N with respect to the time-compression factor T₁. In an embodiment, the content processor 208 may be configured to identify the set of frames of count N with the speech rate R greater than a pre-defined threshold, by using the speech rate contour. Thereafter, the content processor 208, in conjunction with the processor 202, may be configured to assign a binary value to each of the one or more frames. The processor 202 may assign a binary value “1” to the identified set of frames and a binary value “0” to the remaining one or more frames. However, the content processor 208 may further assign a binary value “0” to the frames associated with the other sounds despite the speech rate R being greater than the pre-defined threshold. The binary values associated with each of the one or more frames correspond to the metadata of the multimedia content for the time-compression factor T₁.

In another embodiment, the content processor 208 may be configured to utilize video content of the multimedia content along with the audio content. The content processor 208 may identify the frames in the set of frames in which the instructor in the multimedia content writes on a display board (e.g., a black board or white board) by using one or more image processing operations, such as Sobel operation, known in the art. Thereafter, the content processor 208 may assign a binary value “0” to the frames in which the instructor writes on the display board but a binary value “1” to the frame in which the instructor finishes writing (i.e., the display board is completely filled) remaining one or more frames.

A person having ordinary skill in the art will understand that the abovementioned example is for illustrative purpose and should not be construed to limit the scope of the disclosure.

### Identity of a Speaker in Audio Content:

In an embodiment, the content processor 208 may be configured to cluster the one or more frames based on the identity of speakers in the audio content. Before clustering the one or more frames, the content processor 208 may be configured to identify speech and non-speech portions in the audio content of the multimedia content. The content processor 208 may utilize one or more speech processing techniques, such as zero-crossing technique, to identify the speech and the non-speech portions of the audio content. Thereafter, the content processor 208 may be configured to identify frames among the one or more frames that are associated with the speech portion. Further, the content processor 208 may cluster the frames associated with the speech portion based on the identity of speakers in the speech portion of the audio content. The content processor 202 may utilize one or more speech processing techniques, such as pitch tracking and formant tracking, known in the art for identifying the speakers in the speech portion. Further, the content processor 208 may utilize one or more clustering algorithms, such as k-means clustering, known in the art for clustering the frames associated with the speech portion.

In an exemplary scenario, the content processor 208 identifies that amongst “1000” frames in the multimedia content (i.e., the educational content), frames “1-150,” “175-300,” “320-350,” “380-490,” “515-600,” “637-756,” “810-923” and “967-989” are associated with the speech portion of the audio content of the educational content. The content processor 208 determines the identities of one or more speakers, such as the instructor, the plurality of students, and the other sounds in the speech portion. Thereafter, the content processor 208 clusters the identified frames associated with the speech portion based on the determined identities. Table 1, as shown below, illustrates the clusters, the frames associated with the speech portion in each cluster, and the corresponding identity of speaker associated with the clustered frames.

TABLE 1
Clusters, frames in each cluster, and corresponding identity
of speakers associated with the clustered frames

| | Frames associated with speech | |
|---|---|---|
| Clusters | portion | Identity of speakers |
| Cluster_1 | 1-150, 515-600, 637-756, and | Instructor |
| | 967-989 | |
| Cluster_2 | 175-300, 380-490, and 810-900 | Plurality of students |
| Cluster_3 | 320-350 and 900-923 | Other sounds |

A person having ordinary skill in the art will understand that the abovementioned exemplary scenario is for illustrative purpose and should not be construed to limit the scope of the disclosure.

After clustering, the content processor 208 may be configured to identify the cluster that comprises the highest count of frames. In an embodiment, the content processor 208 may be configured to identify the set frames of the count N from the identified cluster corresponding to the time-compression factor T₁. For example, with reference to Table 1, the content processor 208 identifies the cluster “Cluster_1” with the highest count of frames. Thereafter, the content processor 208 may identify the set of frames of count “100” corresponding to the time-compression factor (i. e., T₁=10) from the cluster “Cluster_1.”

Thereafter, the content processor 208, in conjunction with the processor 202, may be configured to assign the binary value “1” to the identified set of frames of count N and the binary value “0” to the remaining one or more frames in the multimedia content. The binary values assigned to each of the one or more frames may constitute the metadata of the multimedia content for the time-compression factor T₁. For example, the content processor 208 assigns a binary value “1” to each frame in the identified set of frames of count N=100 and a binary value “0” to the remaining “900” frames of the multimedia content.

### Presence of One or More Pre-Defined Filler Words:

In an embodiment, the content processor 208 may be configured to identify the one or more pre-defined filler words in the audio content of the multimedia content. Examples of the one or more pre-defined filler words may include, but are not limited to, “um,” “uh,” “er,” “ah,” “like,” “okay,” “right,” and “you know.” For identifying the one or more pre-defined filler words in the audio content, the content processor 208 may be configured to convert the audio content into text content by utilizing one or more automatic speech recognition (ASR) techniques. In an embodiment, the processor 202 may be configured to temporally map the text content to the one or more frames of the multimedia content. Thereafter, the content processor 208 may be configured to determine a presence of the one or more pre-defined filler words in the audio content. The content processor 208 may be further configured to identify the set of frames of count N, pertaining to the time-compression factor T₁, from the one or more frames that is associated with the one or more pre-defined filler words with a count less than a pre-determined count threshold. For example, the content processor 208 identifies a frame “a” with text content comprising “10” pre-defined filler words and another frame “b” with text content comprising “2” pre-defined filler words. For a pre-determined count threshold “5,” the content processor 208 identifies frame “b” to be included in the set of frames. For another pre-determined count threshold “15,” the content processor 208 identifies both frames “a” and “b” to be included in the set of frames.

A person having ordinary skill in the art will understand that the abovementioned example is for illustrative purpose and should not be construed to limit the scope of the disclosure.

Thereafter, the content processor 208 may assign a binary value “1” to each frame of the set of frames and a binary value “0” to the remaining one or more frames. The binary values assigned to each of the one or more frames may constitute the metadata of the multimedia content for the time-compression factor T₁.

### Historical Data of the User:

In an embodiment, the historical data of the user may comprise the prior interaction of the user with another multimedia content. The processor 202 may be configured to update the historical data every time a user views new multimedia content. For example, if a user has viewed multimedia content M₁, the historical data of the user may comprise details, such as a topic associated with the multimedia content M₁.

Based on the historical data of the user, the content processor 208 may be configured to identify frames among the one or more frames of the multimedia content that are associated with the previously viewed multimedia content (i.e. the historical data of the user).

In an embodiment, after identification, the content processor 208, in conjunction with the processor 202, may be configured to assign a binary value “0” to the identified frames that are associated with the previously viewed multimedia content. The content processor 208 may further assign a binary value “1” to frames (of count N) in the one or more frames that are not associated with the previously viewed multimedia content. In an embodiment, the frames in the one or more frames that are not associated with the previously viewed multimedia content may constitute the set of frames of count N. Further, the assigned binary values may correspond to the metadata of the multimedia content corresponding to the time-compression factor T₁.

In another embodiment, after the identification, the content processor 208, in conjunction with the processor 202, may be configured to assign weights to the one or more frames in the multimedia content. The content processor 208 may assign higher weights to the frames that are not associated with the previously viewed multimedia content as compared to the frames that are associated with the previously viewed multimedia content. Thereafter, the processor 202 may utilize the graph G, (supra), to identify the set of frames of count N to be included in the time-compressed multimedia content. The processor 202 may utilize equation (2), as shown below, for selecting the set of nodes of count N (i.e., the path P) in the graph G with the minimum sum of distortion metrics:

$$P = {argmin}_{N} {\sum }_{K}^{K - 1} w ( k ) D ( {s}_{0} , {s}_{{m}_{0}} ) \qquad ( 2 )$$

where,

w(k) represents the weight assigned to the frame s₀ (represented by X-axis) of the multimedia content; and

D(s₀, sₘ_{₀}) represents distortion metric of a node comprising frames s₀ and sₘ_{₀}.

Thereafter, the processor 202 may identify the Y-axis counterparts of the selected nodes in the path P as the set of frames of count N to be included in the time-compressed multimedia content. Further, the processor 202 may be configured to assign a binary value “1” to the set of frames (of count N) and a binary value “0” to the remaining one or more frames of the multimedia content. In an embodiment, the assigned binary values to the one or more frames may correspond to the metadata of the multimedia content pertaining to the time-compression factor T₁.

In an exemplary scenario, a user may have opted for a course that comprises a series of educational content. The user may have already viewed n educational content from the series. The historical data comprises details pertaining to topics covered in the already viewed n educational content. Further, the user requests to view the time compressed n+1^{th} educational content in the series. Thereafter, the content processor 208 may identify frames among the one or more frames of the n+1^{th} educational content that are associated with the previously viewed n educational content based on the historical content. Further, the content processor 208 assigns weights to the one or more frames, such that higher weights are assigned to the frames that are not associated with the previously viewed n educational content as compared to the frame that are associated with the previously viewed n educational content. Thereafter, the processor 202 may utilize the graph G of the weighted one or more frames to identify the set of frames of count N. Further, the processor 202 may assign a binary value “1” to the identified set of frames and a binary value “0” to the remaining one or more frames.

A person having ordinary skill in the art will understand that the abovementioned examples are for illustrative purpose and should not be construed to limit the scope of the disclosure. Further, the scope of the disclosure is not limited to determining the metadata based on one attribute of the one or more attributes. In an embodiment, the processor 202, in conjunction with the content processor 208, may utilize a combination of the one or more attributes to identify the set of frames of count N, pertaining to the time-compression factor T₁, for determining the metadata.

Based on the one or more attributes (supra), the processor 202, in conjunction with the content processor 208, may be configured to determine the metadata for the one or more frames in multimedia content based on each of the remaining one or more time-compression factors.

At step 306, a check is performed to determine whether the network bandwidth is greater than the pre-defined bandwidth threshold. In an embodiment, the processor 202 may be configured to check whether the network bandwidth is greater than the pre-defined bandwidth threshold. In an embodiment, if the processor 202 determines that the network bandwidth of a communication channel, in the communication network 108, between the user-computing device 102 and the application server 104 is below the pre-defined bandwidth threshold, control passes to step 308. Else, control passes to step 310.

At step 308, the time-compressed multimedia content associated with determined metadata is transmitted based on at least the time-compression factor in the user request received from the user-computing device 102. In an embodiment, the processor 202, in conjunction with the transceiver 206, may be configured to transmit the time-compressed multimedia content associated with the determined metadata to the user-computing device 102, based at least on the time-compression factor in the user request. The processor 202 may transmit a combination of the multimedia content and the metadata pertaining to the time-compression factor in the received user-request. For example, the user request comprises the time-compression factor T₁. In this scenario, the processor 202 may transmit the multimedia content, associated with the metadata pertaining to the time-compression factor T₁, to the user-computing device 102. Control passes to step 316.

At step 310, the one or more sequential levels of the multimedia content are determined based on the one or more time-compression factors and the determined metadata. In an embodiment, the content processor 208 may be configured to determine the one or more sequential levels of the multimedia content. In an embodiment, the content processor 208 may be configured to determine the one or more sequential levels of the multimedia content based on the one or more time-compression factors and the determined metadata. In an embodiment, each sequential level of the one or more sequential levels may be associated with at least a time-compression factor of the one or more time-compression factors. Further, the count of the one or more sequential levels may be equal to the count of the one or more time-compression factors. In an embodiment, each sequential level of the one or more sequential levels is associated with the set of frames pertaining to the corresponding time-compression factor.

In an exemplary scenario, for the one or more time-compression factors, such as “1,” “2,” “4,” “6,” “8,” and “10,” the processor 202 in conjunction with the encoder 210 may determine “6” sequential levels. The bottommost sequential level (i.e., 1^{st} sequential level) is associated with a highest time-compression factor “10.” Further, the 1^{st} sequential level is associated with the set of frames pertaining to the time-compression factor “10.” Further, the 2^{nd} sequential level is associated with the set of frames pertaining to the time-compression factor “8.” Similarly, the remaining one or more sequential levels are associated with the set of frames pertaining to the corresponding time-compression factors. The topmost sequential level (i.e., 6^{th} sequential level) is associated with the lowest time-compression factor “1.” The 6^{th} sequential level) is associated with a set of frames of the multimedia content pertaining to the time-compression factor “1.”

A person having ordinary skill in the art will understand that the abovementioned exemplary scenario is for illustrative purpose and should not be construed to limit the scope of the disclosure.

In an embodiment, the processor 202, in conjunction with the encoder 210, may be configured to encode the one or more frames to determine the one or more sequential levels. The 1^{st} sequential level comprises information, encoded by the encoder 210, pertaining to the set of frames (i.e., the frames with binary value “1”) associated with the highest time-compression factor “10” in the one or more time-compression factors, such as “1,” “2,” “4,” “6,” “8,” and “10.” Further, the 2^{nd} sequential level comprises information, encoded by the encoder 210, pertaining to additional frames associated with the next lower time-compression factor “8.” In an embodiment, the encoder 210 may encode the information in the 2^{nd} sequential level based on the encoded information in the 1^{st} sequential level. In an embodiment, the additional frames (in the 2^{nd} sequential level) may correspond to frames that are present in the set of frames pertaining to the next lower time-compression factor “8” but absent in the set of frames pertaining to the time-compression factor, such as “10.” Similarly, the 3^{rd} sequential level comprises information, encoded by the encoder 210, pertaining to additional frames pertaining to the next lower time-compression factor “6.” In an embodiment, the encoder 210 may encode the information in the 3^{rd} sequential level based on the encoded information in the 2^{nd} sequential level. In an embodiment, the additional frames (in the 3^{rd} sequential level) may correspond to frames that are present in the set of frames pertaining to the next lower time-compression factor “6” but absent in the combination of the set of frames pertaining to the time-compression factors, such as “10” and “8.” Similarly, the encoder 210 may encode information for each of the remaining one or more sequential levels.

In an embodiment, the encoded information may comprise the set of frames and the corresponding time-mapped audio content of the multimedia content in a coded format. In an embodiment, the processor 202 may be configured to store the one or more sequential levels of the multimedia content in the database server 106 and/or the memory 204.

At step 312, a set of sequential levels is selected from one or more sequential levels of the multimedia content associated with time-compression factor in the received user request. In an embodiment, the processor 202 may be configured to select the set of sequential levels from one or more sequential levels of the multimedia content associated with time-compression factor in the received user request. For example, when the user request comprises a time-compression factor “10” (i.e., the highest time-compression factor), the processor 202 may select the 1^{st} sequential level (i.e., the set of sequential levels) associated with the time-compression factor “10” (i.e., the highest time-compression factor). When the user request comprises another time-compression factor “6,” the processor 202 may select the 3^{rd} sequential level and all sequential levels (i.e., the 1^{st} sequential level and the 2^{nd} sequential level) below the 3^{rd} sequential level to constitute the set of sequential levels.

A person having ordinary skill in the art will understand that the abovementioned example is for illustrative purpose and should not be construed to limit the scope of the disclosure.

At step 314, the time-compressed multimedia content associated with determined metadata is transmitted to the user-computing device 102. In an embodiment, the processor 202 may be configured to transmit the multimedia content associated with the determined metadata to the user-computing device 102. Further, the transmitted multimedia content comprises the selected set of sequential levels.

At step 316, the transmitted multimedia content is rendered on the user-computing device 102 as the time-compressed multimedia content. In an embodiment, the processor 202, in conjunction with the transceiver 206, may be configured to render the transmitted multimedia content on the user-computing device 102 as the time-compressed multimedia content.

In an embodiment, when the transmitted multimedia content corresponds to the combination of the multimedia content and the determined metadata, the multimedia content is rendered on the user-computing device 102 by utilizing the metadata-driven player in conjunction with the one or more media player applications installed in the user-computing device 102. In an embodiment, the metadata-driven player may be configured to read the metadata associated with the transmitted multimedia content. Further, the metadata-driven player may be configured to drop the frames with the binary value “0” and retain the frames with the binary value “1.” The metadata-driven player may be further configured to clip the audio content of the multimedia content that is associated with the dropped frames. Thereafter, the one or more media player applications may be configured to render the retained frames and the clipped audio content, in sync, on the user-computing device 102. The synchronized combination of the retained frames and the clipped audio content corresponds to the time-compressed multimedia content.

In an alternate embodiment, when the transmitted multimedia content corresponds to the selected set of sequential levels, the encoded information in the set of sequential levels is decoded by the one or more media player application installed in the user-computing device 102. Thereafter, the decoded information (i.e., the time-compressed multimedia content) is rendered on the user-computing device 102. Control passes to end step 318.

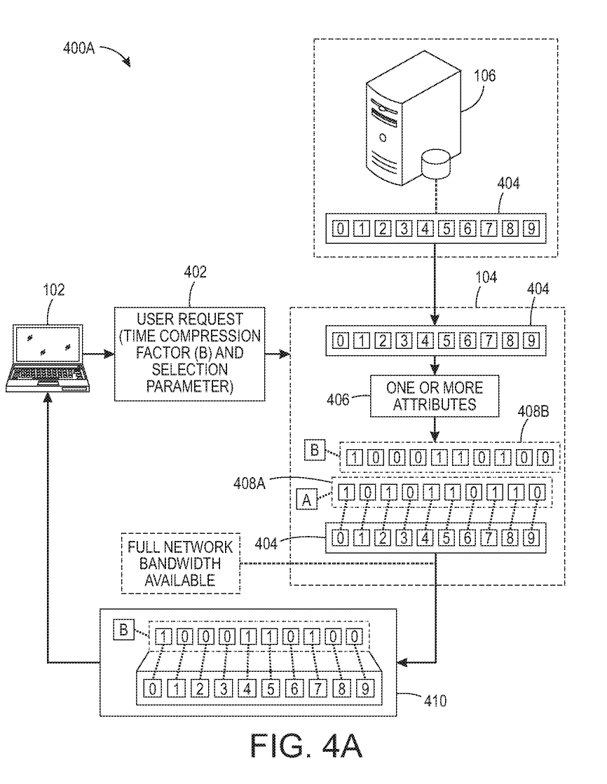

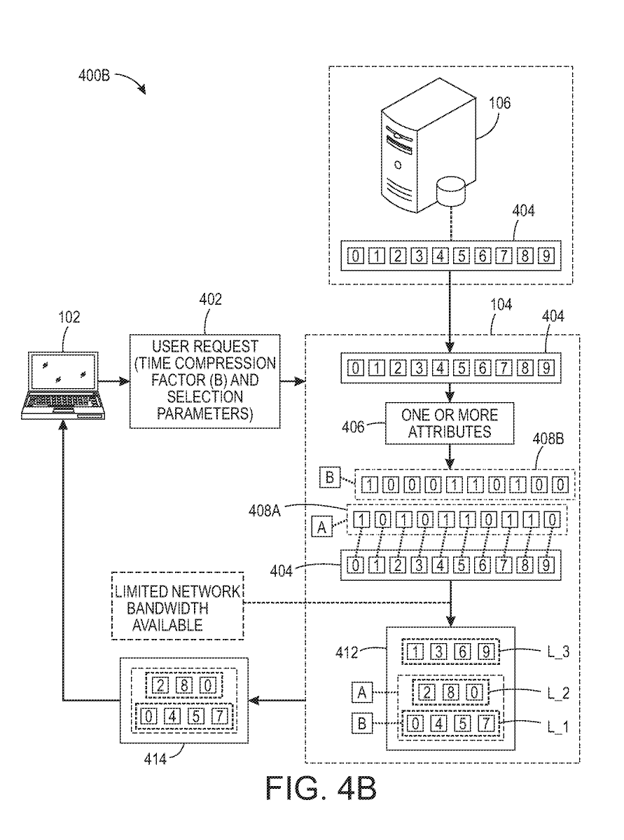

FIG. 4A is an illustrative example for rendering time-compressed multimedia content on a user-computing device when network bandwidth is greater than the pre-defined bandwidth threshold, in accordance with at least one embodiment. With reference to FIG. 4A, there is shown an exemplary system 400A that has been explained in conjunction with FIGS. 1-3.

A user utilizes the user-computing device 102 to transmit a user request 402 to render a time-compressed version of multimedia content 404 on the user-computing device 102. The user request 402 comprises a selection parameter of the multimedia content 404 and a time-compression factor “B.” Based on the selection parameter in the received user request 402, the application server 104 queries the database server 106 to retrieve the multimedia content 404. The multimedia content 404 comprises one or more frames, such as frames “0” to “9.”

Thereafter, the application server 104 processes the multimedia content 404 for determining one or more attributes 406 of the multimedia content 404 corresponding to each of one or more time-compression factors (i.e., “A” and “B”). The one or more attributes 406 comprise a count of frames to be included in the time-compressed version of the multimedia content 404, a speech rate, an identity of a speaker in audio content of the multimedia content 404, presence of one or more pre-defined filler words, and historical data of the user.

Further, the application server 104 determines metadata (i.e., first metadata 408A and second metadata 408B) based on each of the one or more time-compression factors, such as “A” and “B,” and the one or more attributes 406 of the multimedia content 404. For example, the first metadata 408A is determined based on the time-compression factor “A” and the one or more attributes 406 of the multimedia content 404 corresponding to the time-compression factor “A.” Similarly, the second metadata 408B is determined based on the time-compression factor “B” and the one or more attributes 406 of the multimedia content 404 corresponding to the time-compression factor “B.” Further, the determined metadata (i.e., the first metadata 408A and the second metadata 408B) comprises binary values associated with each of the one or more frames (i.e., frames “0” to “9”) of the multimedia content 404. For example, frame “2” in the multimedia content 404 is associated with a binary value “1” in the first metadata 408A and another binary value “0” in the second metadata 408B. The frames in the multimedia content 404 that are associated with the binary value “1” in the metadata constitute the set of frames for the corresponding time-compression factor (i.e., “A” or “B”). For example, frames “0,” “2,” “4,” “5,” “7,” and “8” are associated with binary value “1” in the first metadata 408A corresponding to the time-compression factor “A.” Thus, the frames “0,” “2,” “4,” “5,” “7,” and “8” constitute the set of frames for the time-compression factor “A.” Similarly, frames “0,” “4,” “5,” and “7” constitute the set of frames for the time-compression factor “B.” Further, the application server 104 stores the metadata (i.e., the first metadata 408A and the second metadata 408B) in the local memory.

Thereafter, the application server 104 determines whether the network bandwidth is greater than the pre-defined bandwidth threshold. When the full network bandwidth is available, the application server 104 transmits the time-compressed multimedia content 410 associated with determined metadata to the user-computing device 102. The time-compressed multimedia content 410 comprises the multimedia content 404 embedded with the second metadata 408B based on the time-compression factor “B” specified by the user in the user request 402.

Further, the user-computing device 102 renders the time-compressed multimedia content 410 on a display screen of the user-computing device 102. The user-computing device 102 is installed with a metadata-driven player application and one or more media-player applications that work in conjunction to render the time-compressed multimedia content 410. The metadata-driven player reads the second metadata 408B and drops the frames “1,” “2,” “3,” “6,” “8,” and “9” associated with binary value “0” based on the read second metadata 408. Further, the frames “0,” “4,” “5,” and “7” (and corresponding audio content) associated with the binary value “1” are rendered seamlessly on the display screen by the one or more media players.

FIG. 4B is an illustrative example for rendering time-compressed multimedia content on a user-computing device when network bandwidth is below a pre-defined bandwidth threshold, in accordance with at least one embodiment. With reference to FIG. 4B, there is shown an exemplary system 400B that has been explained in conjunction with FIGS. 1-4A. A person having ordinary skill in the art will understand that before checking the network bandwidth, the application server 104 performs similar steps (supra) in FIG. 4A.

When the application server 104 determines that the network bandwidth is below the pre-defined bandwidth threshold and only limited bandwidth is available for transmitting the time-compressed version of the multimedia content 404, the application server 104 determines one or more sequential levels 412 of the multimedia content 404. The one or more sequential levels 412 comprise a 1^{st} sequential level “L_1,” a 2^{nd} sequential level “L_2,” and a 3^{rd} sequential level “L_3.” Further, the 1st sequential level “L_1” is associated with the time-compression factor “B” and the 2^{nd} sequential level “L_2” is associated with the time-compression factor “A.” The 3^{rd} sequential level “L_3” represents a final sequential level that is associated with a time-compression factor “1” (i.e., “no compression”).

Further, the 1st sequential level “L_1” comprises encoded information pertaining to the set of frames (i.e., frames “0,” “4,” “5,” and “7”) associated with the time-compression factor “B.” The 2^{nd} sequential level “L_2” comprises encoded information pertaining to the frames “2,” “8,” and “0,” of the set of frames associated with the time-compression factor “A,” which are not included in the set of frames associated with the time-compression factor “B.” Thus, the combined frames in the 1st sequential level “L_{—} 1” and the 2^{nd} sequential level “L_2” represent the set of frames associated with the time-compression factor “A.” The 3^{rd} sequential level “L_3” comprises encoded information pertaining to the frames “1,” “3,” “6,” and “9” associated with binary value “0” in both the first metadata 408A and the second metadata 408B.

Based on the time-compression factor “B” specified by the user in the user request 402, the application server 104 selects the 2^{nd} sequential level “L_2” and the sequential level (i.e., the 1st sequential level “L_1”) below the 2^{nd} sequential level “L_2.” The selected sequential levels (i.e., the 1st sequential level “L_1” and the 2^{nd} sequential level “L_2”) constitute the set of sequential levels 414.

Further, the application server 104 transmits the set of sequential levels 414 (i.e., the time-compressed multimedia content associated with determined metadata) to the user-computing device 102. Thereafter, the user-computing device 102 decodes the encoded information in the set of sequential levels 414 to render the time-compressed multimedia content (i.e., the frames in the set of sequential levels 414) on the display screen by utilizing the one or more media players.

The disclosed embodiments encompass numerous advantages. The disclosure provides a method and a system for rendering time-compressed multimedia content on a user-computing device. The disclosed method and system utilize one or more attributes of the multimedia content for determining the metadata of multimedia segments, for compression, in the multimedia content. The historical data comprises information pertaining to a prior interaction of one or more users with the multimedia content. The disclosed method and system further utilize one or more attributes determined from the multimedia content for the selection of the set of multimedia segments. The disclosed method and system provide a robust and fast method of rendering the time-compressed multimedia content based on user-defined preferences. An education provider, which uses multimedia content as a mode of education may utilize the disclosed method and system.

The disclosed methods and systems, as illustrated in the ongoing description or any of its components, may be embodied in the form of a computer system. Typical examples of a computer system include a general-purpose computer, a programmed microprocessor, a micro-controller, a peripheral integrated circuit element, and other devices, or arrangements of devices that are capable of implementing the steps that constitute the method of the disclosure.

The computer system comprises a computer, an input device, a display unit, and the internet. The computer further comprises a microprocessor. The microprocessor is connected to a communication bus. The computer also includes a memory. The memory may be RAM or ROM. The computer system further comprises a storage device, which may be a HDD or a removable storage drive such as a floppy-disk drive, an optical-disk drive, and the like. The storage device may also be a means for loading computer programs or other instructions onto the computer system. The computer system also includes a communication unit. The communication unit allows the computer to connect to other databases and the internet through an input/output (I/O) interface, allowing the transfer as well as reception of data from other sources. The communication unit may include a modem, an Ethernet card, or similar devices that enable the computer system to connect to databases and networks such as LAN, MAN, WAN, and the internet. The computer system facilitates input from a user through input devices accessible to the system through the I/O interface.

In order to process input data, the computer system executes a set of instructions that are stored in one or more storage elements. The storage elements may also hold data or other information, as desired. The storage element may be in the form of an information source or a physical memory element present in the processing machine.

The programmable or computer-readable instructions may include various commands that instruct the processing machine to perform specific tasks such as steps that constitute the method of the disclosure. The systems and methods described can also be implemented using only software programming, only hardware, or a varying combination of the two techniques. The disclosure is independent of the programming language and the operating system used in the computers. The instructions for the disclosure can be written in all programming languages including, but not limited to, “C,” “C++,” “Visual C++,” and “Visual Basic.” Further, software may be in the form of a collection of separate programs, a program module containing a larger program, or a portion of a program module, as discussed in the ongoing description. The software may also include modular programming in the form of object-oriented programming. The processing of input data by the processing machine may be in response to user commands, the results of previous processing, or from a request made by another processing machine. The disclosure can also be implemented in various operating systems and platforms, including, but not limited to, “Unix,” “DOS,” “Android,” “Symbian,” and “Linux.”

The programmable instructions can be stored and transmitted on a computer-readable medium. The disclosure can also be embodied in a computer program product comprising a computer-readable medium, with any product capable of implementing the above methods and systems, or the numerous possible variations thereof.

Various embodiments of the methods and systems for rendering time-compressed multimedia content on a user-computing device have been disclosed. However, it should be apparent to those skilled in the art that modifications, in addition to those described, are possible without departing from the inventive concepts herein. The embodiments, therefore, are not restrictive, except in the spirit of the disclosure. Moreover, in interpreting the disclosure, all terms should be understood in the broadest possible manner consistent with the context. In particular, the terms “comprises” and “comprising” should be interpreted as referring to elements, components, or steps, in a non-exclusive manner, indicating that the referenced elements, components, or steps may be present, used, or combined with other elements, components, or steps that are not expressly referenced.

A person with ordinary skills in the art will appreciate that the systems, modules, and sub-modules have been illustrated and explained to serve as examples and should not be considered limiting in any manner. It will be further appreciated that the variants of the above disclosed system elements, modules, and other features and functions, or alternatives thereof, may be combined to create other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules, and are not limited to any particular computer hardware, software, middleware, firmware, microcode, and the like.

The claims can encompass embodiments for hardware and software, or a combination thereof.

While the present disclosure has been described with reference to certain embodiments, it will be understood by those skilled in the art that various changes may be made and equivalents may be substituted without departing from the scope of the present disclosure. In addition, many modifications may be made to adapt a particular situation or material to the teachings of the present disclosure without departing from its scope. Therefore, it is intended that the present disclosure not be limited to the particular embodiment disclosed, but that the present disclosure will include all embodiments falling within the scope of the appended claims.

What is claimed is:

1. A method of data processing for rendering time-compressed multimedia content on a user-computing device, the method comprising:
determining, by one or more processors in a computing device, metadata for one or more frames in multimedia content based on each of one or more time-compression factors and one or more attributes of the multimedia content, wherein the determined metadata comprises a binary value associated with each of the one or more frames of the multimedia content; and
transmitting, by the one or more processors in the computing device, the multimedia content associated with the determined metadata to the user-computing device, based at least on a time-compression factor in a user request received from the user-computing device, wherein the transmitted multimedia content is rendered on the user-computing device as the time-compressed multimedia content.

2-19. (canceled)

20. A computer-implemented method for rendering core information from time-compressed multimedia content, comprising:
receiving a request from a computing device for the time-compressed multimedia content, wherein the time compressed multimedia content comprises the core information;
selecting multimedia content for purposes of creating the time-compressed multimedia content based on a selection parameter;
determining one or more attributes from the selected multimedia content, wherein the one or more attributes comprise at least one of frame count to be included in the time-compressed multimedia content, a speech rate, identity of a speaker in audio content of the selected multimedia content, presence of one or more predefined filler words, and historical data of a user submitting the request;
determining metadata for one or more frames in the multimedia content based one or more time-compression factors and on the determined one or more attributes of the selected multimedia content; and
transmit the selected multimedia content associated with the determined metadata for rendering the time-compressed multimedia content at the computing device.

21. The computer-implemented method of claim 20, wherein the request comprises the one or more time-compression factors and the selection parameter for selecting the multimedia content.

22. The computer-implemented method of claim 20, wherein the determining of the one or more attributes is based on the one or more time-compression factors.

23. The computer-implemented method of claim 20, wherein the determined metadata comprises binary values associated with each of the one or more frames of the selected multimedia content.

24. The computer-implemented method of claim 20, wherein the determining of the metadata comprises determining the frame count to be included in the time-compressed multimedia content.

25. The computer-implemented method of claim 24, wherein the determining of the frame count comprises
determining a ratio between a count of the one or more frames in the multimedia content and a time-compression factor to determine the frame count,
using the frame count, identifying a set of frames from the one or more frames to be included in the time-compressed multimedia content, and
assigning a binary value ‘1’ to the identified set of frames and assigning a binary value ‘0’ to the remaining one or more frames.

26. The computer-implemented method of claim 25, wherein the identifying the set of frames further comprises
determining the count of frames N as defined by
$$N ≡ \frac{K}{{T}_{1}}$$
where K is frames and T₁ is a time-compression factor; and
building a graph comprising a plurality of nodes, wherein each of the plurality of nodes in the graph indicate a mapping between one frame of the multimedia content represented by an x-axis and another frame represented by a y-axis;
determining a path through the graph that comprises
$$\frac{K}{{T}_{1}}$$
jumps, wherein the determining of the path comprises determining a distortion metric for each node in the graph;
selecting a set of nodes from the plurality of nodes of count N in the graph with a minimum sum of distortion metrics as defined by
$$P = \frac{argmin}{N} {\sum }_{K = 0}^{K - 1} D ( {S}_{0} , {S}_{{m}_{0}} )$$
where D(S₀,Sₘ_{₀}) represents distortion metric of a node comprising frames s₀ and Sₘ_{₀}; and
identifying y-axis counterparts in a select set of nodes as a set of frames of count N to be included in the time-compressed multimedia content.

27. The computer-implemented method of claim 20, wherein the determining of the metadata comprises determining the speech rate associated with the audio content in the multimedia content.

28. The computer-implemented method of claim 27, further comprising:
determining a speech rate contour for the determined speech rate associated with the audio content, wherein
the speech rate contour comprises a temporal mapping of the determined speech rate with the one or more frames of the multimedia content.

29. The computer-implemented method of claim 20, wherein the determining of the metadata comprises
identifying a speaker in the audio content.

30. The computer-implemented method of claim 29, wherein the identifying of the speaker comprises
clustering the one or more frame associated with a speech portion of the audio content based on an identity of one or more speakers, and
identifying the cluster with highest count of frames.

31. The computer-implemented method of claim 20, wherein the determining of the metadata comprises
detecting the presence of the one or more predefined filler words.

32. The computer-implemented method of claim 31, wherein the determining of the presence comprises
temporally mapping text content to the one or more frames of the multimedia content.

33. The computer-implemented method of claim 20, wherein the determining of the metadata comprises determining one or more sequential levels of the multimedia content, when network bandwidth is below a predefined bandwidth threshold.

34. The computer-implemented method of claim 33, wherein each of the one or more sequential levels is associated with one of the one or more time-compression factors.

35. The computer-implemented method of claim 33, wherein each of the one or more sequential levels comprises a set of frames from the one or more frames of the multimedia content.

36. The computer-implemented method of claim 33, further comprising:
determining a set of frames to be included for each of the one or more sequential levels based on binary values in the determined metadata associated with one of the more time-compression factors of each of the one or more sequential levels.

37. The computer-implemented method of claim 20, wherein the historical data of the user comprises prior interaction of the user with another multimedia content.

38. The computer-implemented method of claim 20, further comprising:
updating the historical data every time the user views a new multimedia content.

39. The computer-implemented method of claim 38, wherein the updating of the historical data comprises
based on the historical data of the user, identifying the frames among one or more frames of the multimedia content associated with previously viewed multimedia content;
assigning a binary value “1” to frames in the one or more frames not associated with the previously viewed multimedia content, or
assigning higher weights to the frames in the one or more frames not associated with the previously viewed multimedia content;
utilizing a graph that comprises
$$\frac{K}{{T}_{1}}$$
jumps to identify the set of frames of count N to be included in the time-compressed multimedia content; and
selecting a set of nodes of count N in the graph with a minimum sum of distortion metrics, as defined by
$$P = \frac{argmin}{N} {\sum }_{K = 0}^{K - 1} D ( {S}_{0} , {S}_{{m}_{0}} )$$
where w(k) represents weight assigned to the frame S₀ represented by x-axis of the multimedia content, and
where D(S₀,Sₘ_{₀}) represents distortion metric of a node comprising frames s₀ and Sₘ_{₀};
identifying y-axis counterparts of the selected nodes in path P as a set of frames of count N to be included in the time-compressed multimedia content.
